(19) United States
(12) Patent Application Publication
(10) Pub. No.: US 2005/0011965 A1
(43) Pub. Date: Jan. 20, 2005

(54) Method and means for injecting fuel

(76) Inventor: Alan Patrick Casey, Queensland (AU)

Correspondence Address: MERCHANT & GOULD PC, P.O. BOX 2903, MINNEAPOLIS, MN, 55402-0903, US

(21) Appl. No.: 10/493,996

(22) PCT Filed: Oct. 24, 2002
(86) PCT No.: PCT/AU02/01434

(30) Foreign Application Priority Data
Oct. 30, 2001 (AU) PR 8545

(51) Int. Cl. F02D 1/06; F02M 39/00; F02M 59/00

(52) U.S. Cl. 239/5; 239/533.2; 239/533.3

(57) ABSTRACT

A method of conditioning a fuel charge delivered by a fuel injector into a combustion zone comprises directing combusted fluids from the combustion zone to mix with an injected fuel charge prior to the charge entering the combustion zone. The invention also includes an adaptor unit (10) for mounting the fuel injector, the adaptor including a stepwise expanding nozzle (12) and fluid inspiration means.

### TECHNICAL FIELD

The present invention relates to a method and means for providing combustible mixtures which may be appropriate for internal and/or external combustion engines as applicable to, say, the injection of fuel into a combustion chamber or region. In particular, the method and means of the present invention is applicable to the injection of fuel for ignition in environments requiring the provision of heat and/or increased pressure.

### BACKGROUND ART

Existing fuel injection methods and systems include direct and indirect injection. A major issue with fuel injectors is a desire to improve combustion process by minimising the droplet size of fuel particles prior to combustion. In my inspiration nozzle of U.S. Pat. No. 6,010,077, the contents of which are incorporated herein by reference, I have disclosed an effective means for reducing the fuel particle size delivered by a fuel injector so as to condition the fuel charge prior to combustion so that the quality of that combustion is improved.

Related disclosures concerned with the field of the present invention are shown in U.S. Pat. No. 5,735,468 and WO 00/40856, the contents of which are incorporated herein by reference. DISCLOSURE OF INVENTION

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

The present invention, in a first aspect, proposes a method and means of conditioning a fuel charge delivered by an injector into a combustion zone by recirculating combusted fluids from the combustion zone via inspiration with a charge of fuel from the injector prior to the charge entering the combustion zone.

In a second aspect of the present invention there is provided an adaptor unit for mounting a fuel injector whereby the fuel sprayed from the outlet of an injector mounted in the adaptor is inspirated by a pressurised airflow so as to pass through a stepwise expanding nozzle before entering into a combustion zone. The downstream expanding stepwise nozzle as aforesaid, in an embodiment of this aspect of the invention, is fitted with at least one further inspiration zone downstream of the aforesaid stepwise expanding nozzle. In a further embodiment the at least one further inspiration zone is upstream of at least one expanding nozzle.

In a third aspect the present invention provides nozzle constructions and methods for feeding vaporised liquid droplets with inspirations of gases and/or liquids.

### BRIEF DESCRIPTION OF DRAWINGS

The present invention will now be described by way of example with reference to the accompanying drawings, in which:

FIG. 1 is cross-sectional view through a fuel injector to be mounted to a nozzle and air addition and air inspiration adaptor of a first embodiment of the second aspect of the present invention;

FIG. 2 is a cross-sectional view of the components of the embodiment of FIG. 1 when coupled ready for use in a method and system in accord with an embodiment of the first aspect of the present invention;

FIG. 3 is similar to FIG. 2 while applying a different nozzle arrangement;

FIG. 4 is a similar view to FIG. 2 which employs a still further embodiment of nozzle;

FIG. 5 is a view similar to FIG. 2 but showing a fourth embodiment of a nozzle;

FIG. 6 is a view similar to FIG. 2 but showing a fifth version of nozzle;

FIG. 7 is a view similar to FIG. 2 but of an embodiment comprised of a still further form of inspirated nozzle;

FIG. 8 is a view similar to FIG. 2 but of an embodiment combining the nozzle of FIG. 6 with a third inspiration nozzle of the embodiment of FIG. 2;

FIG. 9 is a cut-away perspective view of an internal combustion engine in accordance U.S. Pat. No. 5,713,314 incorporating an embodiment of a setup of one embodiment of the first aspect of the present invention employing an adaptor of an embodiment of the second aspect;

FIG. 10 is a view of the engine of FIG. 7 from another direction;

FIG. 11 is a cross-sectional view of a Bourke engine, as shown at http://bourkeengine.com, employing a method, system and adaptor of an embodiment of the first and second aspects of the present invention;

FIG. 12 is a view of a Bourke engine similar to that of FIG. 11 but employing an alternate embodiment of the first aspect of the present invention;

FIG. 13 is partial cut-away perspective view of a combustion chamber and head of a two-stroke direct injection arrangement employing an embodiment of the first and second aspects of the present invention;

FIG. 14 is a partial cut-away perspective view of a cylinder head and combustion chamber of a four stroke engine with a direct injection system employing embodiments of the aspects of the present invention; and

FIG. 15 is a cut-away perspective view similar to that of FIG. 9 or 10 but using the timing piston as an air compressor.

### BEST MODES

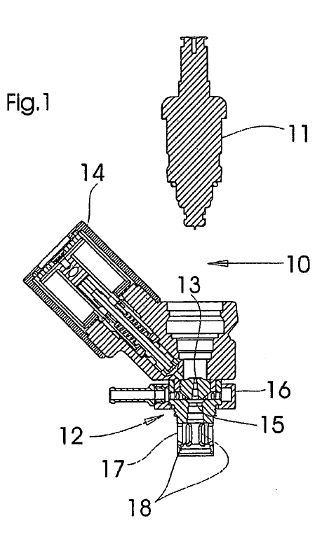

In the drawings of FIGS. 1-8 there is shown a variety of nozzle arrangements mounted in adaptors 10 for feeding compressed air or gas to the outlet spray or mist of a fuel injector 11 housed in the adaptor 10.

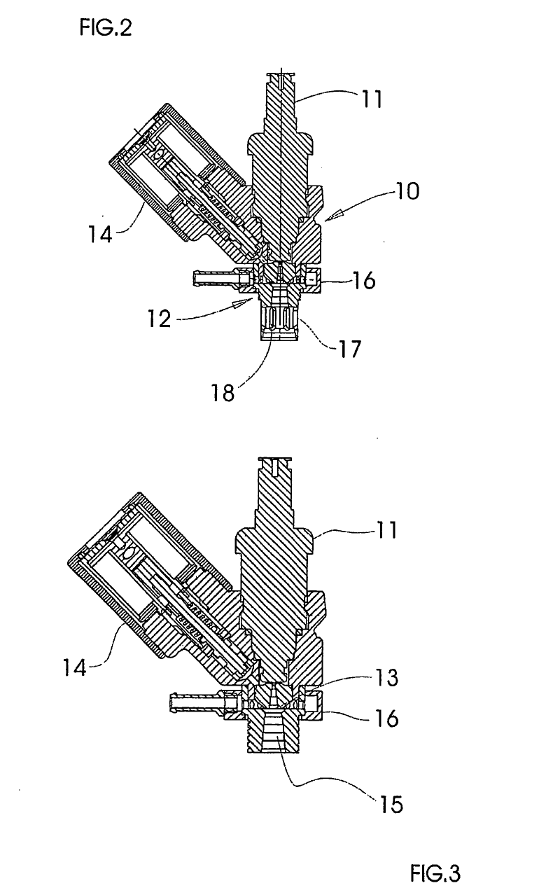

The nozzle arrangement 12 of the embodiment shown by FIGS. 1 and 2 is formed from three stages. In the first stage 13 air and or gas is fed at pressure via a solenoid controlled valve 14. Valve 14 is timed to open before the fuel charge is emitted by injector 11 and closed after the injector charge thereby allowing a clearing of residue liquids from the nozzle arrangement 12

The pressure fed air and/or gas is forced through an orifice, which expands through a venturi type nozzle. The negative pressure created by this flow inspirates the metered flow of liquid through the orifice of first stage 13 pulverising the liquid. The expanding stepped portions of this first nozzle stage 13 continue to break up the fuel particles by breaking fuel adherence and by sudden expansion as well as via negative pressure zones from vortices created by the steps. Normally one could expect that this nozzle would require the addition of about 1% of the total air required for complete combustion using liquid fuels.

The second stage 15 utilises the negative pressure available from the expanding gasses to create inspiration of a much larger mass of gas and/or vapour (as much as or higher than 4 times the primary air or gas mass through first stage 13). This additional fluid is mixed through the secondary nozzle and film adherence continues to be broken. The larger fluid mass increases the available energy for vaporisation and gives a higher premix ratio. This air and/or gas can be heated as disclosed in WO 00/40856 or can be provided by exhaust gas in accord with the first aspect of this invention. Higher premix increases volatility and the possibility of complete combustion. The air or exhaust gas is fed via a plenum chamber 16 and can be fed from a remote source such as an exhaust or a manifold.

The third stage 17 is generally used for inspiration from, say, the main flow of gases into the combustion zone and is shaped so as to allow a minimum pressure drop through the intake holes 18. It also serves to shield the mixture from being forced against the sidewalls of an intake manifold when feeding such a manifold.

This nozzle can also inspirate as much as or higher than 4 times its initial entry mass of mixed gasses giving a possible overall premix of 20%.

The nozzle arrangement of FIG. 3 is a two stage setup. The first stage 13 is the same as that of FIGS. 1 and 2. The second stage 15 of this embodiment functions in the manner of the second stage shown in FIGS. 1 and 2.

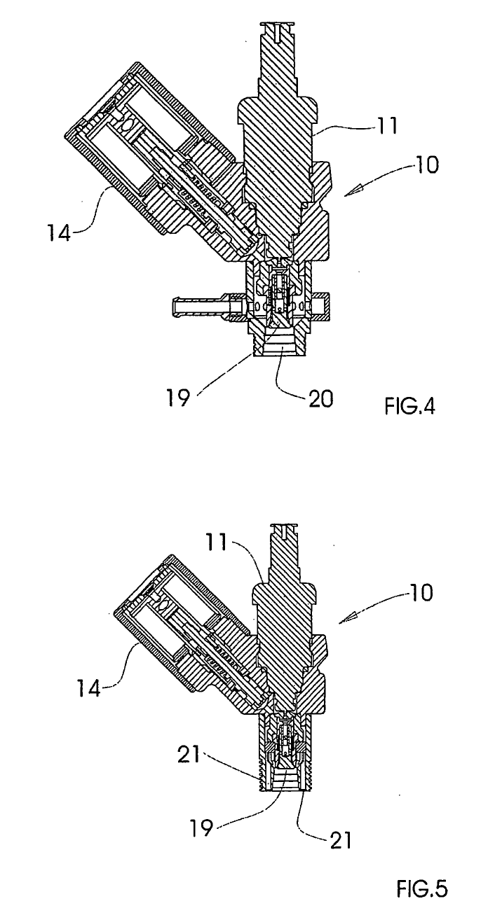

The nozzle of the FIG. 4 embodiment is also a two stage arrangement like that of FIG. 3. In this case, however, the first stage incorporates a check valve 19 to protect the internals of the nozzle and injector 11 from back pressure. The nozzle arrangement of this embodiment can be used for direct injection. The check valve 19 is spring-loaded and opens with air pressure and is closed by spring and compression pressure.

The second stage 20 of this embodiment functions in the manner of the second stage of the embodiment of FIG. 3.

The nozzle of the embodiment of FIG. 5 is a two stage arrangement with a first stage of the type of the embodiment of FIG. 4.

In this case the second stage inspiration air is fed back from the front of the nozzle through holes 21 axially extant and disposed radially so as to be exposed to the injection chamber. This results in a balanced condition and allows gasses to recirculate to increase premix and vaporisation through inspiration.

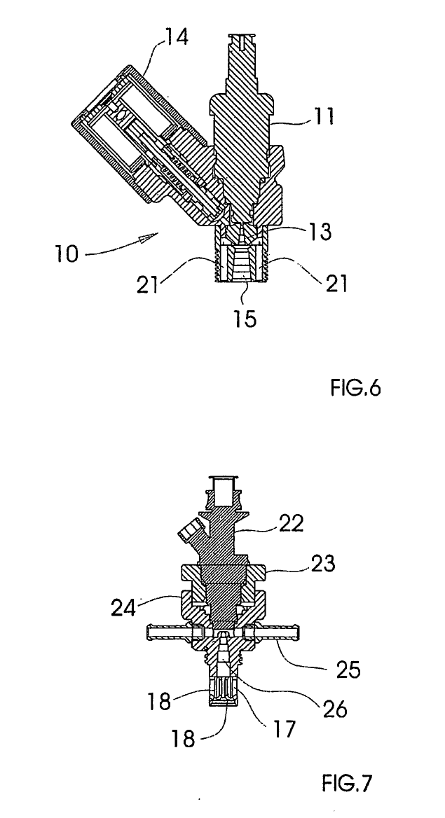

The embodiment of FIG. 6 is also of a two stage nozzle with its first stage 13 functioning in similar manner to the first stage of the embodiments of FIGS. 1 and 2.

In this embodiment the second stage inspiration air is fed back from the front of the nozzle through radially disposed holes exposed to the injection chamber in the manner of the second stage of the embodiment of FIG. 5 but without the check valve.

In FIG. 7 the embodiment comprises a proprietary fuel injector 22 mounted in a mating piece 23. Mating piece 23 is threadedly connected to adaptor 24 which contains a dual air or gas inlet system 25 for inspirating the outlet spray from the injector 22 to feed the combined fuel and gas mix through step nozzle 26 which feeds into a second inspiration zone substantially of the form of the third inspiration zone of the embodiment of FIGS. 1 and 2.

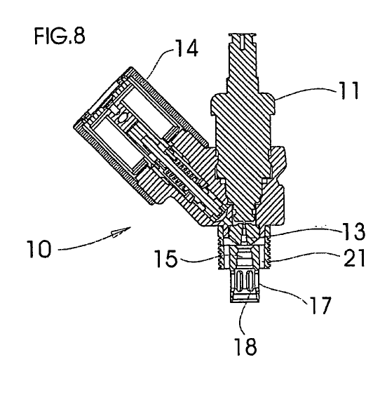

The embodiment shown by FIG. 8 is essentially a combination of the embodiment of FIG. 6 when fitted with a third inspiration nozzle of the kind employed in the embodiment of FIGS. 1 and 2.

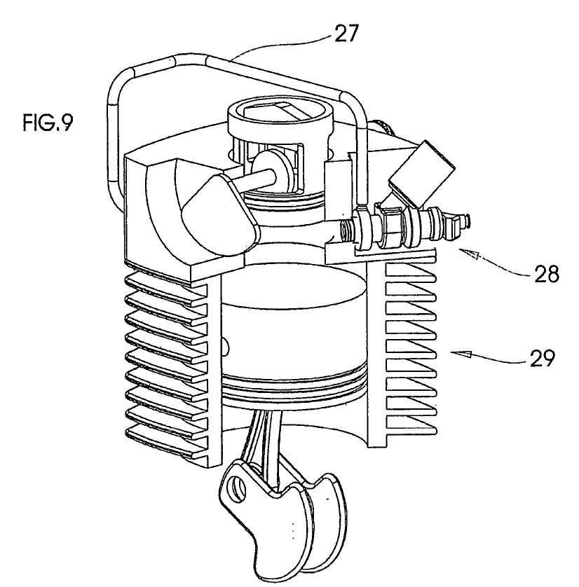

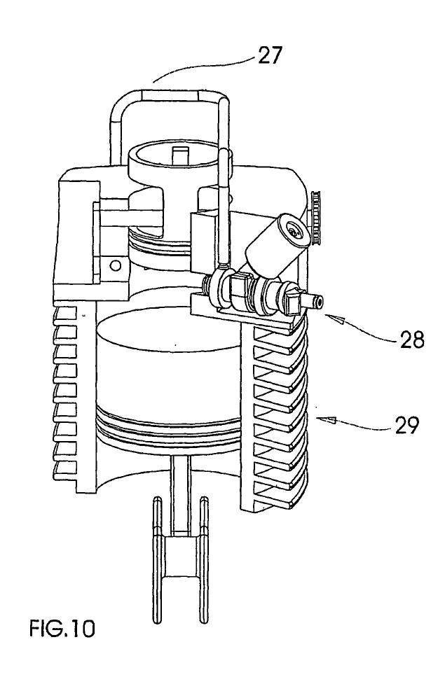

The depictions of FIGS. 9 and 10 show one embodiment of the use of recirculated combustion gases via line 27 as the inspiration fluid into the nozzle of an injector arrangement 28 in accordance with anyone of FIGS. 1 to 6 in the environment of an internal combustion engine 29 of the form disclosed in U.S. Pat. No. 5,713,314.

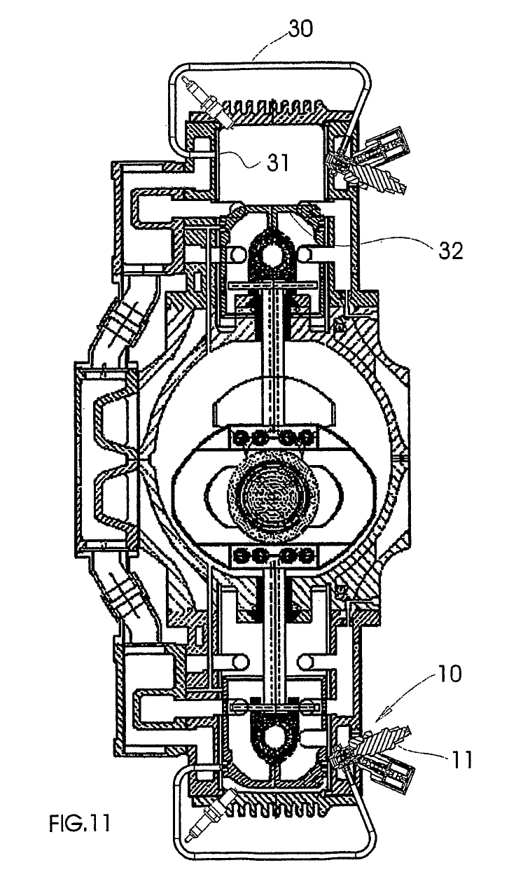

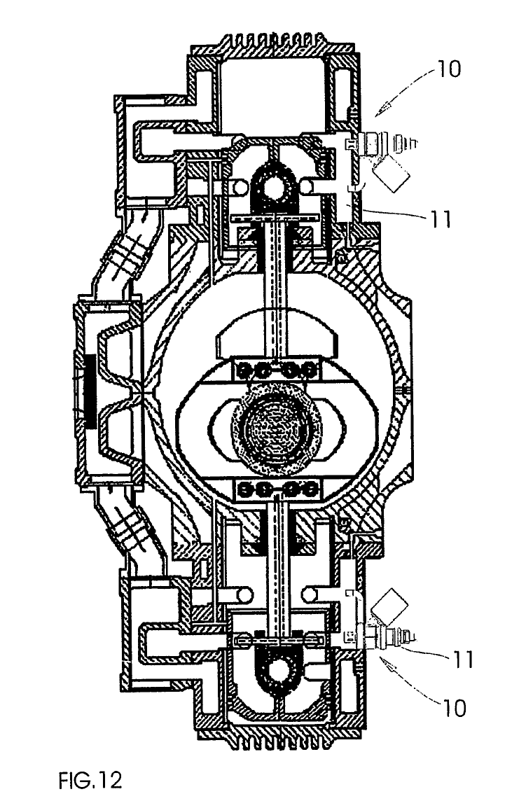

The engine of FIGS. 11 and 12 is fitted with two alternate arrangements in accord with aspects of the present invention. The embodiment of FIG. 11 provides for direct injection by an arrangement in accord with any one of the embodiments of FIGS. 1-8. In the case where the secondary inspiration gases are fed in via a plenum as per the embodiments of FIGS. 1-4, such secondary gases arrive from the combustion chamber via a recirculation pipe or line 30. The inlet 31 to line 30 as well as the outlet from the final nozzle into the combustion chamber is closed off from the combustion zone by the movement of piston rings on piston 32 past those locations prior to detonation. As can be seen, recirculation of gases from the combustion chamber via line 30 occurs between the inlet and outlet valves of the engine.

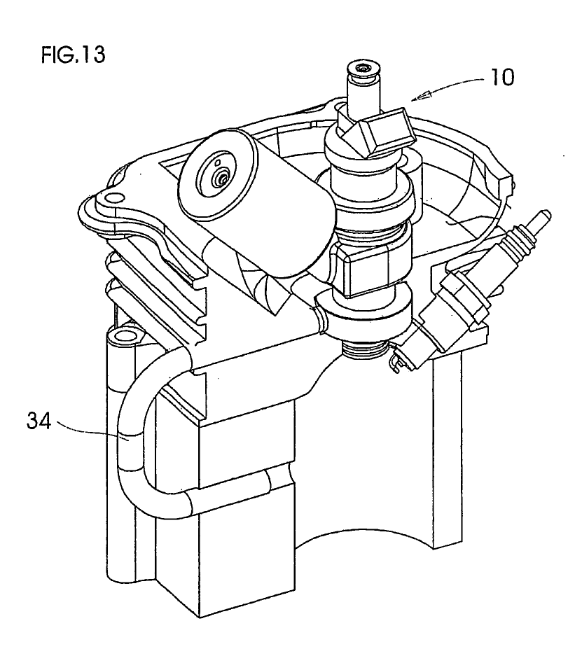

The embodiment of FIG. 12 employs indirect injection into a manifold or transfer channel 33 of a two-stroke diesel Bourke engine. The embodiment of FIG. 13 shows a set up for two-stroke direct injection with combustion chamber recirculation. In this embodiment the nozzle employed is the type of FIG. 4 or 5 which uses a check valve to protect the injector and nozzle passages from combustion products.

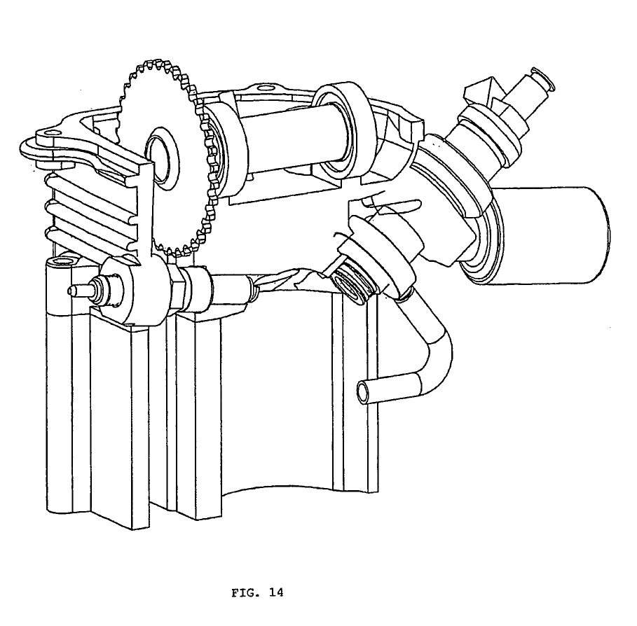

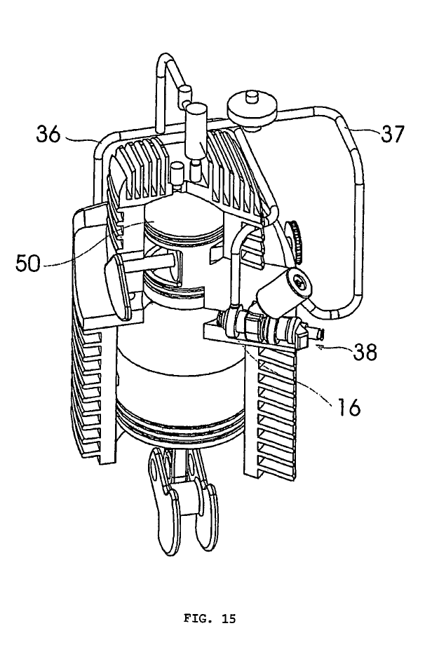

The embodiment of FIG. 14 is an example of a four-stroke direct injection system equivalent to the two-stroke arrangement of the FIG. 13 which also uses a check valve within the nozzle for the same reason as in the embodiment of FIG. 13.

In a four-stroke indirect manifold injection as shown by FIGS. 1 and 3 disclosed in WO 00/40856, air is fed via a ram tube to inspirate fuel from the injector nozzle outlet and to be fed to the combustion chamber via a poppet valve. The air travelling through the ram tube has a start and stop motion due to the opening and closing of the valve. The faster the valve opens and closes the more rapidly the motion of the air in the ram tube must start and stop. The effect of this is to cause the air in ram tube to compress and expand at greater and greater speeds until a standing wave is formed in the ram tube.

When liquid fuel is presented into the inlet manifold it contacts the standing wave in the ram tube and is flung against the walls of the manifold. The fuel is then wiped off the walls and the cycle is repeated until the fuel charge reaches the poppet valve before being drawn into the cylinder through the open valve.

In an engine running at a high speed the preparation of the fuel charge in an indirect injection environment makes little difference to the quality of that charge due to the interference effects of the standing wave. That difficulty must be contrasted with the benefits that occur for a low revving engine even though film adherence has an effect on the diminution of the quality of each charge.

Such problems can be ameliorated by direct injection using an atomising air addition at about 1% of the stoichiometric ratio by mass. By using an arrangement employing a nozzle set up as shown by FIG. 3 or 4 a substantially improved result can be achieved. With those nozzles it is possible to inspirate as much as four times more air from within the combustion chamber to get a premix of up to 5% of stoichiometric when only 1% is initially presented through the first inspiration nozzle.

In the case of the embodiment of FIGS. 9 and 10 the third inspirating nozzle can facilitate inspirating four times the 5% premix to give an ultimate premix of 20% of stoichiometric. The recirculation of combustion chamber gases provides additional temperature to the premix so as to further vaporise the fuel prior to combustion.

In particular, for an engine in accord with U.S. Pat. No. 5,735,468 the benefits of the nozzle can be significant due to the protection afforded the nozzle arrangement by the timing piston which shields the nozzle from the extreme pressures and temperatures encountered during the explosion and expansion process within the engine. The best nozzle for this purpose from the depicted embodiments is that of FIG. 2 or FIG. 8. Those nozzles allow recirculation of up to 20% of gases within the cylinder during the injection period; thereby creating an atmosphere where maximum pre-mixing and vaporisation can take place in the nozzle and within the confines of the reed valve and the rotary exhaust valve. This is an advantage over existing designs in that a check valve is not necessary allowing for a simpler design and significant inspiration performance. The third stage of the nozzle can also be used without interfering with the valving of the engine. A check value may be used when deemed necessary, as in the case of a supercharged or turbocharged engine.

In the embodiment of FIG. 15 there is shown an engine in accord with U.S. Pat. No. 5,735,468 having the additional feature of valve timing piston 50 atop combustion chamber 51 being formed as a compressor piston to feed compressed air into the exhaust gas recirculation line 36 on the one hand and as the source for pressurised air via line 37 to be inspirated by the solenoid controlled valve of the injector and inspiration valve unit 38 at the first inspiration zone. In this way the valve timing piston 50 provides a secondary function in conjunction with an engine of the type disclosed in U.S. Pat. No. 5,735,468 to thereby provide a compact arrangement for producing compressed air for use in the engine combustion or otherwise. Unit 38 can be in the form shown by any one of the embodiments of FIGS. 1-8.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A method of conditioning a fuel charge delivered by a fuel injector into a combustion zone, said method comprising directing combusted fluids from the combustion zone to mix with an injected fuel charge prior to the charge entering the combustion zone.

2. A method as claimed in claim 1 wherein the directed combusted fluids are mixed with the injected fuel charge via an inspiration zone downstream of a fuel injector outlet.

3. An adaptor unit for mounting a fuel injector, said adaptor unit comprising a stepwise expanding nozzle for receiving and directing fuel injected by said injector and wherein first fluid inspiration means is adapted to feed pressurized air to the injected fuel upstream of the nozzle.

4. An adaptor as claimed in claim 3 wherein said first fluid inspiration means comprises a valve controlled to open and close relative to the flow of fuel injected by the injector when mounted in the adaptor whereby the pressurized air passes through the valve.

5. An adaptor as claimed in claim 4 wherein the valve is controlled by solenoid means.

6. An adaptor as claimed in claim 3 comprising at least one further fluid inspiration zone associated with said stepwise expanding nozzle.

7. An adaptor as claimed in claim 6 wherein the at least one further inspiration zone is located downstream of the stepwise expanding nozzle.

8. An adaptor as claimed in claim 6 comprising at least one expanding nozzle downstream of said stepwise expanding nozzle.

9. An adaptor as claimed in claim 8 wherein said at least one expanding nozzle is a further stepwise expanding nozzle.

10. A nozzle for an adaptor unit for mounting a fuel injector, said nozzle including a stepwise expanding zone in a downstream flow direction, a first inspiration zone for directing a first fluid to be inspirited into the fuel flow leaving the stepwise expanding zone when the nozzle is in use to receive fuel from a fuel injector, a second inspiration zone downstream of the first inspiration zone for inspiriting a second fluid into the fuel and first fluid mixture.

11. A nozzle as claimed in claim 10 further including a third inspiration zone downstream of the second inspiration zone.

12. A nozzle as claimed in claim 10 wherein the second inspiration zone foods the second fluid radially of the downstream direction.

13. A nozzle as claimed in claim 10 wherein the second inspiration zone feeds the second fluid axially of the downstream direction.
